(19) United States
(12) Patent Application Publication
(10) Pub. No.: US 2026/0265063 A1
(43) Pub. Date: Sep. 10, 2026

(54) NANO PARTICLE DEPOSITION SYSTEM AND RELATED METHODS

(71) Applicant: Bright Sand Industries, Inc., Detroit, MI (US)

(72) Inventor: Earl R DECKER, Windsor (CA)

(73) Assignee: Bright Sand Industries, Inc., Detroit, MI (US)

(21) Appl. No.: 19/253,606

(22) Filed: Jun. 27, 2025

Related U.S. Application Data
(60) Provisional application No. 63/665,182, filed on Jun. 27, 2024.

(51) Int. Cl. C01B 32/16; B01J 8/08; B01J 8/10; C01B 3/52

(52) U.S. Cl. CPC C01B 32/16; B01J 8/087; B01J 8/10; C01B 3/52; B01J 2208/00398; B01J 2208/00761; B01J 2208/00867; C01B 2203/0415; C01B 2203/049

(57) ABSTRACT

A device and method for producing carbon nanotubes and hydrogen from carbon-containing materials are disclosed. The device includes a first module that thermally processes the carbon-containing material to generate a carbon-containing gas, and a second module with a fixture that captures carbon-containing particles from the gas. The fixture is connected to an electrical power source. The method involves heating the carbon-containing material to produce a gas stream, capturing particles on a fixture, producing nanoparticles from the captured particles, and harvesting them. The device and method can utilize various configurations and materials to optimize the production process.

### RELATED APPLICATIONS

The present application claims benefit from earlier filed U.S. Provisional Application No. 63/665,182, filed Jun. 27, 2024, which is incorporated by reference in its entirety for all purposes.

### TECHNICAL FIELD

The present disclosure relates to a nano particle deposition module and a method thereof, and more particularly, relates to a system and apparatus for converting plastic waste into carbon nanotubes and hydrogen.

### BACKGROUND

The increasing accumulation of plastic waste in the environment has become a significant global concern. Plastics, due to their durability and resistance to degradation, persist in landfills and natural habitats, leading to pollution and harm to wildlife. Traditional methods of plastic disposal, such as landfilling and incineration, pose environmental risks, including soil and water contamination and the release of greenhouse gases. As a result, there is a growing need for innovative solutions that can effectively manage plastic waste while minimizing environmental impact.

In recent years, the focus has shifted towards converting plastic waste into valuable resources, thereby addressing both waste management and resource scarcity issues.

Technologies that can transform plastic into useful materials, such as carbon nanotubes and hydrogen, offer promising avenues for sustainable development. Carbon nanotubes, with their exceptional strength and electrical conductivity, have applications in various industries, including electronics, energy storage, and materials science. Hydrogen, as a clean energy carrier, has the potential to reduce reliance on fossil fuels and lower carbon emissions. The development of efficient systems for converting plastic waste into these valuable products is crucial for advancing circular economy principles and achieving environmental sustainability.

### SUMMARY OF THE DISCLOSURE

The device may produce carbon nanotubes and hydrogen from carbon-containing materials. The device can include a first module that thermally processes the carbon-containing material into a carbon-containing gas, a second module fluidly connected to the first module, and a fixture inside the second module that captures carbon-containing particles from the gas. The fixture may be connected to an electrical power source.

Some examples of the device may have the first module comprising a reactor, which can be in a rotary reactor, a batch configuration reactor, or a gas stream generator. The reactor in some examples may heat the carbon-containing materials to temperatures ranging from 300 °C to 800 °C. The reactor environment can be an inert environment without the presence of oxygen to allow the material to undergo pyrolysis.

The first module in some examples may further include a plasma discharge device.

The fixture may comprise two electrodes, each connected to the respective terminals of the electrical power source, and can receive an electrical signal input. A plurality of wires or flat ribbons may be attached to the two electrodes, forming a grid pattern. The plasma discharge unit can be either thermal or non-thermal. Thermal discharge module will contain two or more electrodes, plates or mesh wire, while a non-thermal discharge device will have two or more electrodes with a dielectric barrier between.

In some examples, the fixture may include ultrafine tungsten wire to increase the density of suitable sites for collecting nanoparticles. In some cases, the ultrafine wire can be composed of other metals such as molybdenum, copper, and other conductive materials.

The fixture may be positioned so that the carbon-containing gas passes through it.

The plurality of wires or flat ribbons in the fixture can be composed of materials such as stainless steel, aluminum, copper, tungsten, and some other electrically conductive materials.

The device may further include a system to modulate properties of the electrical signal input, including current, sine wave shape, frequency, amplitude, and pulsing alternating frequencies.

A method may produce carbon nanotubes and hydrogen from carbon-containing materials by processing the material through heating to between 300 °C and 800 °C, producing a carbon-containing gas stream in a first module, capturing particles on a fixture in a second module, producing nanoparticles on the fixture, and harvesting them.

The method may further include impregnating the nanoparticles on the fixture with an impregnation solution forming meta materials.

The impregnation solution in some examples may comprise materials such as iron, cobalt, nickel, platinum, palladium, rhodium, copper, ruthenium, zinc, and some other catalytically active metals.

The fixture in the method may comprise two electrodes connected to an electrical power source, with wires or flat ribbons forming a grid pattern.

The method may include passing an electrical signal input through the wires on the fixture.

The method may also involve modulating the properties of the electrical signal input, including current, sine wave shape, frequency, amplitude, and pulsing alternating frequencies.

The carbon-containing materials in the method may comprise waste materials.

### LIST OF FIGURES

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a plan view drawing of a reactor;

FIG. 2 shows a plan view of a fixture;

FIG. 3 shows a reactor chamber;

FIG. 4 shows a photograph of a fixture being made;

FIG. 5 illustrates a flow chart of the presently disclosed process, and

FIG. 6 illustrates a plan view of the presently disclosed fixture.

### DETAILED DESCRIPTION

Plastic is vaporized in the first module to 500 C (can be continuous and or batch). The module can be operated in a low oxygen, argon and or vacuum atmosphere. A plasma discharge is actuated in the module to increase activity. The vaporized plastic gas is passed through to a second module containing the presently disclosed fixture.

The fixture has two parallel bars attached to tungsten electrodes. Wires are attached to each bar and run parallel between the two bars. The electrodes are attached to a power supply which provide a current that is carried to the bars and then through the wires. The current can be AC, DC or a combination of the two. The AC and DC currents can be run concurrently or at different times. The overall current can be modulated individually or in combination with one or more of the following electrical current properties: current, sine wave shape, frequency, and amplitude.

The wires of the fixture can attract carbon-containing molecules from the process stream that can arrange themselves onto the wire as nano particles including nanotubes. Unwanted particles can be repelled by utilizing varying frequencies.

The fixtures can be arraigned back-to-back to form a line of individual fixtures. The fixtures can be arraigned back-to-back with varying support structures comprising different compositions of the bars, electrodes, and wires. The fixtures can include the wire arranged in a single folded accordion style to support one continuous mesh of electrodes and wires.

Additionally, the process values for each in the module will vary with the variations in the structural relationships between the various components, and the material composition thereof.

Nano particles can be harvested from the fixtures through mechanical removal, liquid immersion, and other established procedures.

Fixtures containing the supported nano particles can be used as the support material for modulating catalysts. In some embodiments, the fixture is now comprised of nanocarbon particles including in many cases, nanocarbon tubes, in a 360-degree formation around each of the support surfaces, including for instance, wire, tube, ribbon, and heat pipe.

This fixture can now be used as a catalyst support in a separate process to filter out and capture carbon-containing material.

By impregnating the fixture with specific catalyst pre-cursor material, the fixture can become a modulating catalyst. The heat pipes in the fixture can be used to capture the carbon nano particles, then the fixture can be impregnated with catalyst particles, such as iron/nickel, to form a modulating catalyst.

The fixture can now be used in a catalytic reaction process, such as Fischer-Tropsch process, using the properties of the heat pipe to control the temperature of the catalyst while operating an electrical current through the carbon nanotube supported catalyst particles to increase the efficiency of the reaction.

The process can be utilized with an array of catalyst systems including, for example, Sabatier, Fischer-Tropsch (FT) synthesis, methanol synthesis, ammonia synthesis (via Haber-Bosch process) and steam reforming.

Catalyst formulations useful for the above reactions are well known and include the following: Sabatier process can utilize nickel and/or ruthenium-based catalysts; FT reaction can be run over iron/nickel supported catalysts; methanol synthesis can utilize copper/zinc oxide catalyst formulations; ammonia synthesis can typically be run over iron-containing formulations, and steam reforming catalysts can include nickel catalysts. These are exemplary formulations for the reactions set forth above and the present disclosure is not limited to those catalysts or reactions listed above.

The presently disclosed method allows a current to be passed through the carbon-supported catalyst which can be utilized to de-foul and regenerate the catalyst.

### Hypersonic Shielding

Hypersonic shielding is used to protect vehicles and other objects from the very high heat and stress that is generated during hypersonic flight. Hypersonic refers generally to speeds over Mach 5.

The presently disclosed fixture can be utilized to produce sheets of material that provide increase shielding properties for objects travelling at over Mach 5. In one embodiment of the current teachings, tungsten wire can be utilized in the fixture to form an electrode sheet. The electrode sheet can then be used as a substrate for carbon nanotube growth using the presently disclosed method. The carbon nanotubes can then be impregnated with cobalt and iron to form a composite sheet of CNT's with Co-Fe on layered thereon. In some embodiments, the order of addition of the CNT's and the impregnation with Co, Fe can be altered.

This sheet of material can be magnetized to form a thin sheet of magnetized material. It is understood that this sheet of material can then be used to increase the standoff distance, or in other words provide hypersonic shielding. It is further understood that there is the potential to harvest energy from the plasma which can increase the strength of the magnetic field and also increase the standoff distance.

These thin film materials produced by the presently disclosed method could be used in the production of batteries, electronics, and other materials, such as building materials.

### Plasma Field

In some embodiments of the present teachings, a plasma field can be initiated in the sealed reactor module containing hydrocarbon gas from vaporized plastics, including PET (polyethylene terephthalate), at 500 °C can significantly affect the reaction conditions.

A plasma is an ionized gas and is formed by adding enough energy to the gas to strip electrons from atoms or molecules, thus creating the mixture of ions, electrons, and neutral particles making up the plasma. At 500 °C, the gas is already thermally excited, so ionization is easier when an external energy source (like an electric field or electromagnetic waves) is applied.

The energy required to maintain the gas in the plasma state can come from either an AC or DC power source. The AC source can provide high-frequency oscillations that help to sustain the plasma, while the DC source can provide a continuous flow of energy.

The high energy environment of a plasma can break down complex hydrocarbon molecules into simpler fragments, such as hydrogen, methane, ethylene, acetylene, and other smaller hydrocarbons. This breakdown process is known as plasma pyrolysis.

The high energy plasma field generates a large number of highly reactive species, including radicals (such as H·, CH·, C₂H·) which can lead to a variety of chemical reactions that are not possible under normal thermal conditions.

Under the right conditions, a plasma can facilitate the formation of carbon nanoparticles, fullerenes, or even carbon nanotubes from the ionized hydrocarbon gas. The controlled environment of the sealed reactor is conducive to formation of these high-value byproducts. In some embodiments, a desirable outcome is the production of hydrogen gas (H₂) as a byproduct. This production occurs as the hydrogen atoms present in the hydrocarbon feedstream are first liberated and then recombine to form H₂.

Plasma driven processes are usually highly efficient in terms of energy usage compared to traditional thermal processes. The high energy density and reactivity mean that reactions can occur rapidly and at generally lower overall temperatures. The plasma parameters such as temperature, pressure, and energy input need to be precisely controlled to ensure the desired reactions occur and to avoid unwanted byproducts.

The choice between AC and DC sources for plasma power depends on the specific requirements of the process. AC plasmas are typically more uniform and can be sustained over a wide range of frequencies, while DC plasmas can provide more control over the ionization energy and can be more stable in certain configurations.

According to various embodiment of the present teachings, the reactor should be properly sealed and designed to withstand the high temperatures and pressures involved. The materials used for the reactor and electrodes need to be compatible with the reactive plasma environment to avoid degradation and contamination.

Initiating a plasma field in a sealed reactor containing vaporized PET at 500 °C can significantly enhance the breakdown of hydrocarbons, leading to the formation of simpler molecules, hydrogen gas, and potentially valuable carbon nanomaterials. The process efficiency and control are greatly improved compared to conventional methods, however, careful management of the reactor conditions and energy inputs is of great import.

According to various embodiments of this disclosure, it is desirable to vary the AC signal frequency from 1 Hz to 500 Hz and adjust the DC voltage from 5V to 30V, utilizing a combination of a function generator and a variable DC power supply. One of skill in the art will know necessary characteristics of the equipment needed to generate the desired variations of both the AC and DC currents. Some of the characteristics include a variable DC power supply (5V to 30V), a function generator (1 Hz to 500 Hz), a properly sized coupling capacitor (value depending on the application), an oscilloscope for monitoring the signal, and a breadboard or soldered circuit board to provide stable connections.

A suitable capacitor can have a value suitable for the frequency range, a typical value could be in the range of 0.1 μF to 10 μF. The capacitor's voltage rating needs to be higher than the maximum DC voltage.

### Saltwater Flow Battery

Incorporating the presently disclosed nanocarbon materials into saltwater flow battery electrolytes can significantly enhance their performance. The unique properties of the disclosed nanocarbon materials can address some of the inherent challenges of saltwater flow batteries, particularly in terms of energy density, conductivity, and stability. Saltwater flow battery electrolytes can benefit from the use of the presently disclosed nanocarbon materials in several ways including enhanced conductivity, increased electrochemical surface area, catalytic activity, and improved stability and longevity.

Of particular interest for this battery are the CNTs produced on the tungsten wires of the fixture and then impregnated with a catalyst-containing formulation to provide the catalyst materials supported and/or intermeshed with the CNT structure produced by the presently disclosed method and apparatus. These presently taught nanocarbon structures, when integrated into the electrolyte, can provide a conductive network, facilitating ion transport between the electrodes. This can be especially beneficial if the metal ions form a part of this conductive network, potentially reducing internal resistance and increasing the overall efficiency of the battery.

Another benefit derived from the use of nanocarbon materials is the increased electrochemical surface area available for reactions of the nanostructured carbon materials. This property can lead to a higher capacity to store energy, as more ions can interact with the electrode surfaces, potentially improving the energy density of the battery.

Catalytic activity can also be increased with certain metal ions specifically by enhancing the redox reactions occurring at the electrodes. This can improve the charge/discharge rates, making the battery more responsive and efficient. For example, metal ions like nickel or cobalt can facilitate oxygen evolution and reduction reactions, crucial in many types of flow batteries.

The batteries can also exhibit improved stability and longevity which is believed to be due to the structural stability of the disclosed nanocarbon materials. When the nanocarbon materials are combined with saltwater-stable metal ions, it is believed that improved longevity and durability of the battery will result. The disclosed materials are understood to be less prone to degradation over repeated charge/discharge cycles.

There are a myriad of potential applications for the enhanced saltwater flow battery system such as large-scale energy storage, and renewable energy integration. Incorporating structured nano carbon materials with metal ions into saltwater flow battery electrolytes presents a fascinating avenue for research and development. It combines the safety and environmental benefits of saltwater electrolytes with the high performance and efficiency of advanced nanomaterials, potentially leading to the next generation of energy storage systems.

Drawing energy from plasma using a composite material made of carbon nanotubes (CNTs) coated with cobalt-iron (Co—Fe) nanoparticles, supported on tungsten wire, involves several innovative and complex steps. This process could harness the unique properties of the materials involved to interact with plasma and convert its energy into usable forms.

### Amplifier Waveform

According to various embodiments of the present teachings, it is understood that the form of the electrical input into the tungsten wires can influence the properties of the carbon-containing materials that are produced by the fixture. One exemplary method to vary the input to the tungsten wires could be to connect the output of the sound amplifier (such as a guitar amplifier) to a waveform extraction circuit. This circuit should filter and amplify the desired waveform, incorporating the modulations of the sound amplifier (for example, treble, bass, gain, reverb, etc.) as needed.

Filters and equalization circuits can be used to adjust the frequency response and tone characteristics of the extracted waveform. Further manipulation of the extracted waveform can be achieved with the modulation signals (treble, bass, gain, reverb) using an amplitude modulation (AM) or frequency modulation (FM) technique. The modulation signals can be used to modulate the amplitude, frequency, or phase of the extracted waveform, adding dynamic variations and effects to the output.

The modulated waveform can be connected to the circuitry responsible for heating the tungsten wire. This connection can be achieved by using an isolation transformer or optocoupler to interface between the modulation circuit and the tungsten wire heating circuit. The connection should insure that the modulation signals are appropriately scaled and conditioned to control the current flowing through the tungsten wire for CNT production.

This modulation system can further include variable control and feedback by implementing variable control mechanisms for the modulation parameters (treble, bass, gain, reverb) to fine-tune the waveform characteristics and optimize CNT production. Additionally, feedback loops and sensors can be used to monitor the temperature and performance of the tungsten wire while adjusting the modulation parameters as needed to maintain optimal conditions.

By integrating the guitar amplifier waveform with multiple modulations into the CNT production process through the tungsten wire, creative variations and enhancements can be introduces to the production process. Adjusting the modulation parameters allows for flexibility and optimization based on production requirements and experimental results.

This disclosure addresses the issue of plastic waste by converting it into CNTs and hydrogen gas. Utilizing a two-module process in an inert atmosphere, the presently disclosed process aims to produce CNTs at a competitive cost, with the added benefit of generating hydrogen gas for power.

The first module vaporizes waste plastic in an inert atmosphere, facilitated by advanced process controllers, such as Groov® EPIC™ hardware, for precise temperature and pressure control. The second module captures carbon atoms in the vapor, assembling them into CNTs on metallic substrates. The post-process gas, primarily hydrogen, is collected for energy generation.

Hydrogen gas, separated from the post-process gas stream, can be used to power a generator, offsetting some of the system's energy requirements. This capture not only enhances the processor's sustainability but also contributes to its economic model.

The first or thermal module is designed for controlled thermal degradation of plastic materials into byproducts such as hydrogen gas and, eventually, CNTs. In some cases, the module uses a rotating drum which allows for the even heating and mixing of plastic waste materials, ensuring consistent thermal conversion. Control of the drum rotation speed manages the residence time and ensures complete conversion of the plastic to gas, with the capability to adjust for variable flow rates of input material.

The presently disclosed heating system can utilize silicon carbide (SiC) rods and SCR (Silicon Controlled Rectifier) controls. SiC heating rods are known for their high thermal conductivity and resistance to thermal shock, making them ideal for the high-temperature environment of the reactor. SCR controls for each heating rod allow for precise temperature management, ensuring that the reactor maintains the optimal temperature for the pyrolysis reaction.

A low oxygen environment needed to prevent complete combustion of the plastics and favoring pyrolysis is maintained by a roots blower and modulating valves. These components control the introduction of air or inert gases to regulate the oxygen level within the reactor, aiding in the control of the reaction atmosphere, and the level of combustion.

After thermal conversion, the process gas, which is at approximately 500 °C, is directed to the second module. The temperature of the exiting gas is crucial for the efficiency of the subsequent process, where larger hydrocarbon molecules are broken down into smaller ones, including nanocarbon precursors and hydrogen.

By adding water into the process stream prior to the Sabatier reactor, it is possible to adjust and optimize the gas mixture for methane production. The sequence could look like this: plastics are pyrolyzed at 600 °C with 3-5% oxygen for 1 minute, resulting in a mixture of gases, including CO, CO₂, H₂, and other hydrocarbons. Water is introduced, prompting the water-gas shift and steam reforming reactions, producing more H₂ and CO₂. The enriched gas mixture is passed into the Sabatier reactor, where the CO₂ is efficiently converted to CH₄. The actual efficiency of this process would depend on various factors like temperature, pressure, catalysts, and the actual gas compositions.

The disclosure provides a system and method for converting carbon-containing materials, such as plastic waste, into carbon nanotubes and hydrogen. The system may include a first module that vaporizes plastic at 500 °C in a low oxygen, argon, or vacuum atmosphere, potentially using a plasma discharge to enhance activity. The vaporized gas may be transferred to a second module containing a fixture with parallel bars and tungsten electrodes. This fixture can attract carbon-containing molecules to form nanoparticles, including nanotubes, by providing a modulated electrical current through wires. The fixture may be arranged in various configurations to optimize nanoparticle formation and can be used as a catalyst support by impregnating it with catalyst precursor materials, such as iron or nickel, to create a modulating catalyst. The process may allow for the mechanical removal or liquid immersion of nanoparticles, contributing to resource conservation and green energy production by converting waste into valuable materials.

In the described system, the first module may thermally process carbon-containing materials, such as plastic, to produce a carbon-containing gas. This process may involve heating the materials to temperatures ranging from 300 °C to 800 °C, potentially utilizing a reactor in various configurations, such as a rotary reactor or a batch configuration reactor. The vaporized plastic gas may then be passed to a second module, which contains a fixture designed to capture carbon-containing particles from the gas. The fixture may include parallel bars attached to tungsten electrodes, with wires running parallel between the bars. These wires may attract carbon-containing molecules, facilitating the formation of nanoparticles, including nanotubes. The electrodes may be connected to a power supply, providing current to the bars and wires, which can be modulated in terms of current, sine wave shape, frequency, and amplitude. This modulation may enable the attraction of carbon-containing molecules and the repulsion of unwanted particles. The fixture may be positioned so that the carbon-containing gas passes through it, allowing for the capture of particles. Additionally, the system may include a plasma discharge device to enhance processing by increasing activity within the module. The overall process may convert plastic into valuable materials, such as carbon nanotubes and hydrogen, while utilizing waste materials.

The fixture may be connected to an electrical power source, which may provide current to the bars and wires. This connection may enable electrical operations that can facilitate the attraction of carbon-containing molecules. The power supply may deliver both AC and DC currents, which may be modulated to optimize the attraction process. The modulation of electrical current properties, including current, sine wave shape, frequency, and amplitude, may control the formation of nanoparticles. The fixture, with its parallel bars and tungsten electrodes, may serve as a component in this process. The AC and DC currents may be run concurrently or at different times, allowing for flexibility in operation. The modulation of these currents may enhance the system's ability to attract and form nanoparticles, including nanotubes. The fixture's design, with wires running parallel between the bars, may support the formation of nanoparticles by providing a structured environment for the carbon-containing molecules to arrange themselves. The electrical operations enabled by the power supply may be in achieving the desired outcomes in nanoparticle formation. The system's ability to modulate electrical current properties may provide a means to control the process and optimize the production of nanoparticles.

According to an embodiment, the first module may further comprise a plasma discharge device, which may be actuated to increase activity within the module. This action may enhance the processing of carbon-containing materials, potentially leading to more efficient conversion into carbon-containing gas. The plasma discharge may be utilized to facilitate the breakdown of these materials, thereby optimizing the production of carbon nanotubes and hydrogen. The plasma discharge device may be integrated into the first module to ensure that the processing conditions are conducive to the desired chemical reactions. The plasma discharge may be controlled to maintain the appropriate energy levels required for the thermal processing of the carbon-containing materials. The integration of the plasma discharge device into the first module may allow for a more controlled and efficient processing environment, which may be for the successful production of carbon nanotubes and hydrogen. The plasma discharge may also be used to modulate the properties of the carbon-containing gas, potentially enhancing the capture of carbon-containing particles in subsequent stages of the process. The use of a plasma discharge device in the first module may represent an advancement in the processing of carbon-containing materials, offering the potential for improved efficiency and effectiveness in the production of valuable materials such as carbon nanotubes and hydrogen.

The system may modulate the properties of the electrical signal input, including the properties of current, sine wave shape, frequency, and amplitude. This modulation may control the formation of nanoparticles. The modulation of electrical current properties may be achieved through a system that includes electrical current properties. The modulation may allow for the precise control of the electrical characteristics, which may influence the formation of nanoparticles. The modulation of these properties may be for the effective operation of the system, as it may enable the control of the formation of nanoparticles. The modulation of electrical current properties may be an aspect of the system, as it may allow for the control of the formation of nanoparticles. The modulation of these properties may be achieved through a system that includes electrical current properties, which may allow for the precise control of the electrical characteristics. The modulation of these properties may be for the effective operation of the system, as it may enable the control of the formation of nanoparticles. The modulation of electrical current properties may be an aspect of the system, as it may allow for the control of the formation of nanoparticles. The modulation of these properties may be achieved through a system that includes electrical current properties, which may allow for the precise control of the electrical characteristics. The modulation of these properties may be for the effective operation of the system, as it may enable the control of the formation of nanoparticles.

According to an embodiment, the nano particles may be impregnated on the fixture with an impregnation solution, which may comprise one or more members selected from the group consisting of iron, cobalt, nickel, platinum, palladium, rhodium, copper, ruthenium, zinc, and other catalytically active metals. This impregnation may serve to provide catalytic activity and enhance catalytic properties. The fixture may be impregnated with catalyst particles like iron/nickel, which may create a modulating catalyst. The impregnation solution may be applied to the nano particles on the fixture, potentially forming a modulating catalyst. The catalyst pre-cursor material may be used to impregnate the fixture, which may result in the formation of a modulating catalyst. The process may involve the use of catalyst particles, such as iron/nickel, to impregnate the fixture, thereby forming a modulating catalyst. The fixture, once impregnated, may serve as a modulating catalyst, potentially enhancing the catalytic properties of the system. The impregnation of the nano particles on the fixture with the impregnation solution may be a step in providing catalytic activity and enhancing the catalytic properties of the system. The use of catalytically active metals in the impregnation solution may further enhance the catalytic properties of the fixture, potentially leading to improved performance of the system.

According to an embodiment, the system may include carbon-containing materials that can comprise waste materials. The system may be designed to vaporize plastic and process gas, potentially converting plastic into valuable materials. The carbon-containing materials may be utilized within the system to achieve this conversion. The system may be capable of processing these materials, potentially leading to the production of carbon nanotubes and hydrogen. The vaporization process may involve heating the plastic to a specific temperature, which may result in the formation of a carbon-containing gas. This gas may then be processed further within the system to produce the desired materials. The system may be configured to handle various types of waste materials, allowing for flexibility in the types of materials that can be processed. The conversion process may be facilitated by the system's ability to manage and process the carbon-containing materials effectively. The system may also include components that can support the formation of nanoparticles, which may be a step in the overall process. The potential to convert waste materials into valuable products may offer advantages, including resource recovery and environmental benefits.

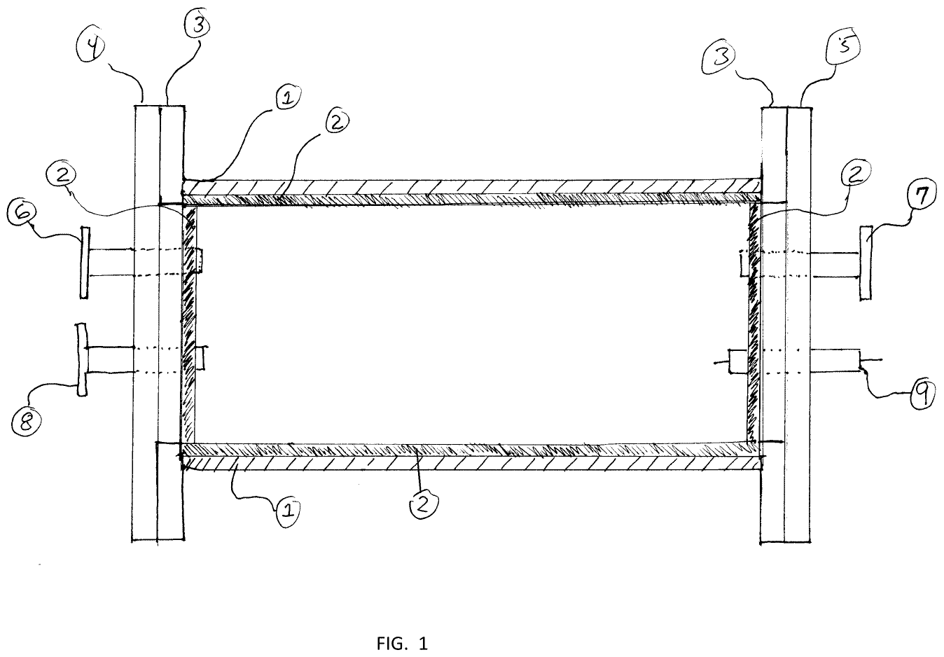

Referring now to FIG. 1, the drawing illustrates one embodiment of a second module 1 designed for producing carbon nanotubes and hydrogen from carbon-containing materials. The chamber wall 1 has a ceramic or other high temperature resistant lining 2 with flanges 3 at both ends. End plates 4 and 5 are attached to both flanges 3. Inert gases and/or a vacuum can be added through the inlet 8 as needed to maintain the desired reactions inside the module 1. Electrical inputs are located at 9 can provide power and/or electrical signal to modulate the properties of wire substrates located on a fixture located (not pictured) in the module 1.

In some embodiments, the end plates 4 and 5 can fluidly connect to, on the left side, a first module which provides a carbon-containing gas through the inlet 6.

In other embodiments (not pictured), usually when the basic reaction conditions are similar, a reaction container can include the carbon-containing gas producer, the plasma generator, and the fixture in one contiguous reaction container. In some cases, with ceramic dividers or flow directors between each separate reaction zone in the same reaction container.

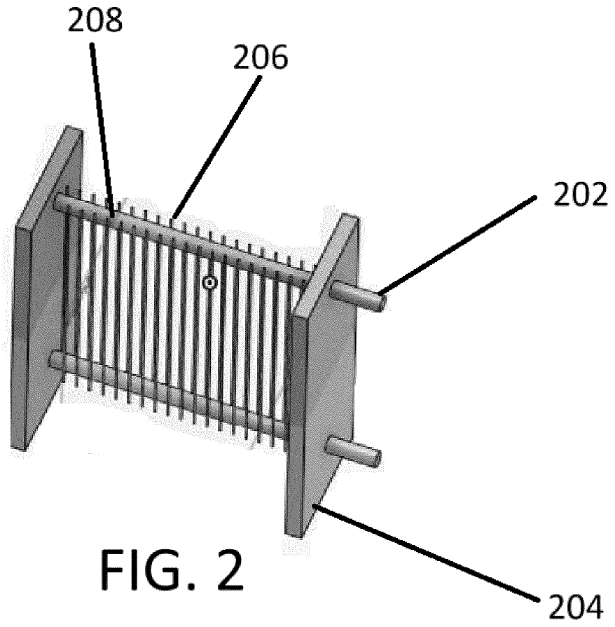

One embodiment of the presently disclosed fixture is illustrated in FIG. 2, with supports 204 holding the electrodes 202 on one end support. Wires 206 are arranged in parallel rows spanning between the two supports/conductive bars 208 which are electrically connected to the electrodes 202 or in some cases are the same bar extended through the supports 204.

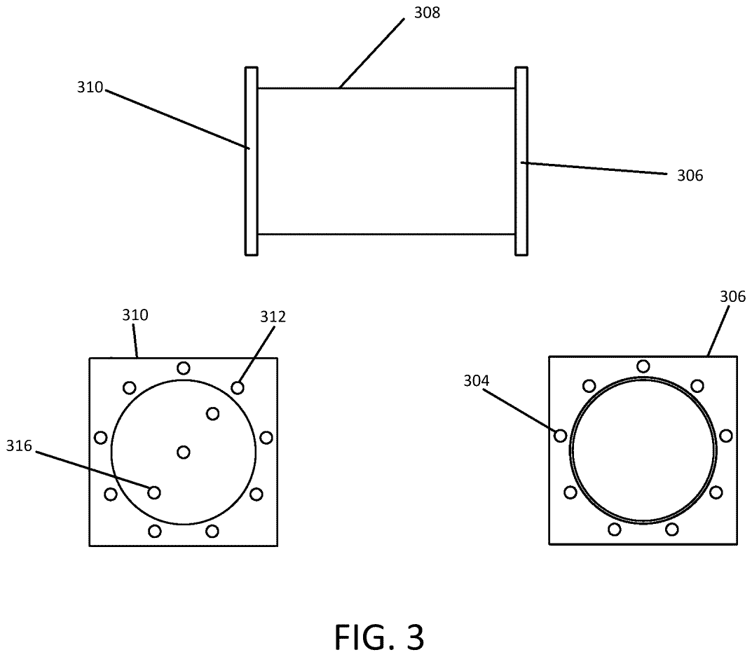

Another embodiment of the present disclosed reaction chamber is pictured in FIG. 3 with the chamber 308 having flanges 306, 310 at each end. The flanges are attached with bolts 304, 312 with either closed or open ends as needed. Electrical connections, sensor ports, gas inlets/outlets are provided with openings 316 as needed for monitoring the subject reaction conditions.

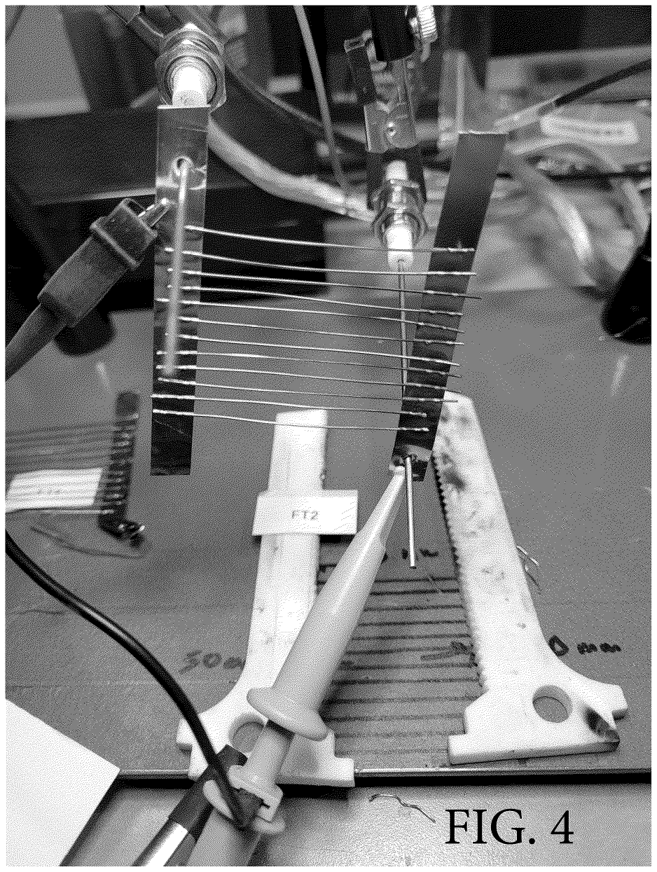

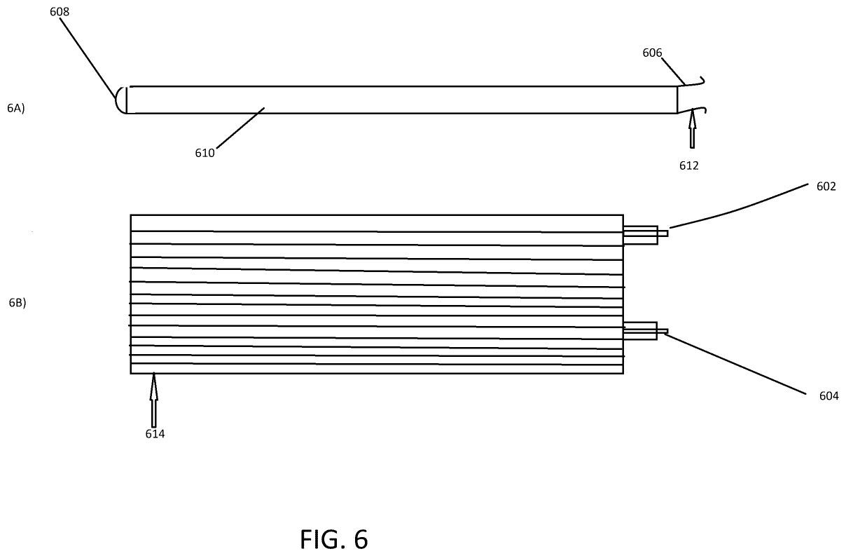

FIG. 4 is a photograph of one example of the presently disclosed fixture being hand constructed. The thinner tungsten wires are arranged horizontally between the thicker supports/conductive bars and welded thereto. Another view of the fixture is illustrated in FIG. 6, a ceramic substrate 610 can be wrapped with the desired wire in any one of a number of possible wrapping patterns including up and back down the length of the substrate, in a spiral fashion wrapping around the smaller dimension of the substrate, in any case, connecting tails 606, 612 can be left at the end of wrapping to allow for connection of the wrapped wire with an electrical power source (not shown). Grid 614 is one possible result of the wrapping procedure with connectors 602, 604 which can be connected to a power source to heat up the wire to desired temperatures, and also to receive electrical input signals to modulate the properties of carbon nano particles as they attach to the wire grid 614.

The power supply to points 606 and 612 allows the wire on the fixture, which is for modulating the electrical properties of the wire and for the deposition of nanoparticles. The fixture, comprising two electrodes connected to a power source, can utilize this heating element to attract carbon-containing molecules from the gas stream. These molecules then arrange themselves onto the wire as nanoparticles, including nanotubes, facilitated by the heat generated.

The interaction between the power supply and the wire is for achieving the desired temperature, which enhances the efficiency of nanoparticle formation. The ability to modulate the electrical signal, including current, sine wave shape, frequency, and amplitude, further optimizes the process by repelling unwanted particles and ensuring the precise deposition of carbon nanotubes. This setup allows for the continuous or batch operation of the system, contributing to the overall functionality and effectiveness of the device in converting plastic waste into valuable materials.

Referring now to FIG. 6, the illustration depicts a fixture integral to the production of carbon nanotubes and hydrogen. This fixture is designed to capture carbon-containing particles from a gas stream, a step in the conversion of carbon-containing materials into valuable nanomaterials. The fixture comprises fine tungsten wires 608 and a tungsten wire looped 608 at one end, both strategically positioned on a ceramic substrate 610. These components are for the deposition of nanoparticles, including carbon nanotubes, as they provide a surface for the carbon-containing molecules to adhere to and form nanoparticles.

The tungsten wires are connected to an electrical power source capable of delivering both DC and AC currents, with the ability to modulate frequency. This electrical setup is for enhancing the deposition process, as it allows for the manipulation of electrical properties such as current, sine wave shape, frequency, and amplitude. The modulation of these properties can optimize the conditions for nanoparticle formation and ensure the efficient capture of desired particles while repelling unwanted ones. The wires or filaments may also be coated with a catalyst to further enhance the deposition process, aligning with the goal of producing high-quality carbon nanotubes and hydrogen.

The ceramic substrate 610 serves as a stable and heat-resistant base for the fixture, ensuring that the tungsten wires remain securely positioned during the high-temperature processes involved in nanoparticle production. The arrangement of the wires and the looped configuration at one end are designed to maximize the surface area available for particle capture, thereby increasing the efficiency of the process. This setup, as part of the larger device, facilitates the transformation of vaporized plastic gas into valuable nanomaterials, contributing to the environmental and resource conservation benefits highlighted in the embodiments and uses.

This heating capability may assist in modulating the electrical properties or the arrangement of nanoparticles on the fixture. The heating function is for maintaining conditions for nanoparticle deposition and can influence the efficiency and quality of the carbon nanotube formation. The fixture's dual role as both a particle capture mechanism and a heating element underscores its importance in the overall process of converting carbon-containing materials into nanomaterials.

The arrangement of wires and electrodes on the fixture ensures efficient capture and deposition of carbon particles. The fixture can be arranged back-to-back with varying support structures, allowing for flexibility in its application and enhancing its ability to support the formation of carbon nanotubes. The fixture's design, including the use of ultrafine tungsten wire, increases the density of suitable sites for collecting nanoparticles, thereby improving the efficiency of the process.

In the context of the system, this fixture plays a role in capturing carbon-containing particles and facilitating their transformation into nanoparticles, the fixture contributes to resource conservation and green energy production. The ability to modulate electrical signals and repel unwanted particles further enhances the fixture's effectiveness, making it a component in the sustainable conversion of waste materials.

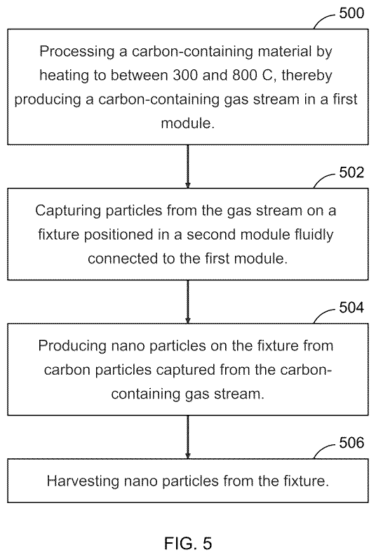

FIG. 5 is a flowchart illustrating a method in step 500 for producing carbon nanotubes and hydrogen from carbon-containing materials, according to an embodiment. At step 500, the carbon-containing material may be processed by heating to a temperature range between 300 C and 800 C within a first module. This process may result in the production of a carbon-containing gas stream. The first module may include a plasma discharge device, which can be actuated to enhance the activity within the module, potentially increasing the efficiency of the gas production process. The carbon-containing materials may comprise waste materials, which can be utilized to convert them into valuable outputs.

The vaporized plastic gas, as a form of carbon-containing gas, may then be passed to a second module that is fluidly connected to the first module. Within this second module, a fixture may be positioned to capture particles from the gas stream. The fixture may consist of two parallel bars attached to tungsten electrodes, with wires running parallel between the bars. These wires may attract carbon-containing molecules from the process stream, allowing them to arrange themselves onto the wire as nanoparticles, including nanotubes. The fixture may be connected to an electrical power source, enabling electrical operations that facilitate the attraction of carbon-containing molecules.

The electrical signal input through the wires located on the fixture may be modulated, including properties such as current, sine wave shape, frequency, and amplitude. This modulation may control the formation of nanoparticles by influencing the electrical characteristics of the system. The fixture may also be impregnated with an impregnation solution, which may include catalyst particles such as iron or nickel. This impregnation may transform the fixture into a modulating catalyst, enhancing its catalytic properties.

The nanoparticles formed on the fixture may be harvested through various methods, such as mechanical removal or liquid immersion. The harvested nanoparticles may include carbon nanotubes, which can be used in various applications. The fixture, now containing supported nanoparticles, may serve as a catalyst support in separate processes, potentially filtering out and capturing additional carbon-containing material. By impregnating the fixture with specific catalyst precursor materials, the fixture may become a modulating catalyst, further enhancing its utility in various catalytic processes.

In step 502, the process may involve capturing particles from the gas stream on a fixture positioned in a second module fluidly connected to the first module. The fixture, which may comprise two electrodes connected to an electrical power source, can be designed to capture carbon-containing particles from the gas stream. The fixture may include parallel bars attached to tungsten electrodes, with wires running parallel between the bars. These wires may attract carbon-containing molecules from the process stream, potentially forming nanoparticles, including nanotubes. The electrical signal input through the wires can be modulated, including properties such as current, sine wave shape, frequency, and amplitude, to enhance the capture and formation of nanoparticles. The second module, fluidly connected to the first module, may facilitate the transfer of vaporized plastic gas to the fixture, allowing for the efficient capture of particles. The use of AC and DC currents, either concurrently or at different times, may further optimize the process by repelling unwanted particles through varying frequencies. This step may be in the overall system for producing carbon nanotubes and hydrogen from carbon-containing materials, as it supports the formation and capture of nanoparticles on the fixture.

In step 504, the process may involve the production of nanoparticles on the fixture from carbon particles captured from the carbon-containing gas stream. The fixture, which may be positioned within the second module, can serve as a component in this process. The fixture may be designed to attract carbon-containing molecules, potentially forming nanoparticles, including nanotubes, on its surface. This attraction may be facilitated by the fixture's configuration, which could include parallel bars attached to tungsten electrodes. These electrodes may be connected to a power supply that provides current, which can be either AC, DC, or a combination of both. The current may be modulated in various ways, including adjustments to the current, sine wave shape, frequency, and amplitude, to optimize the formation of nanoparticles. The modulation of electrical current properties may play a role in controlling the characteristics of the nanoparticles produced. Additionally, the fixture may be impregnated with catalyst particles, such as iron or nickel, to enhance its catalytic properties, potentially transforming it into a modulating catalyst. This impregnation may involve the use of an impregnation solution comprising catalytically active metals. The fixture's ability to support the formation of nanoparticles and its potential use as a catalyst support may be integral to the overall process of converting carbon-containing materials into valuable products.

At step 506, the process may involve the harvesting of nano particles from the fixture. The fixture, which may be positioned within the second module, can serve as a collection point for nano particles that have been formed from carbon particles captured from the carbon-containing gas stream. The fixture may include a grid pattern formed by wires or flat ribbons attached to electrodes, which are connected to an electrical power source. This configuration may allow for the attraction and arrangement of carbon-containing molecules onto the wires as nano particles, including nanotubes. The harvesting of these nano particles may be achieved through various methods such as mechanical removal, liquid immersion, or other established procedures. Additionally, the harvested nano particles may be impregnated with an impregnation solution, which may comprise catalytically active metals like iron, cobalt, nickel, and others. This impregnation may transform the fixture into a modulating catalyst, enhancing its catalytic properties for subsequent processes. The fixture, now containing the supported nano particles, may be used as a catalyst support in separate processes to filter out and capture carbon-containing material. The overall process may be designed to efficiently convert carbon-containing materials, such as waste materials, into valuable nano particles and hydrogen, contributing to resource recovery and environmental sustainability.

All publications, articles, papers, patents, patent publications, and other references cited herein are hereby incorporated by reference herein in their entireties for all purposes. Although the foregoing description is directed to the preferred embodiments of the present teachings, it is noted that other variations and modifications will be apparent to those skilled in the art, and which may be made without departing from the spirit or scope of the present teachings.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What we claim is:

1. A device to produce carbon nanotubes and hydrogen from carbon-containing materials comprising:
a first module that thermally processes the carbon-containing material to a carbon-containing gas;
a second module fluidly connected to the first module;
a fixture positioned inside the second module that captures carbon-containing particles from the carbon-containing gas; and
the fixture is connected to an electrical power source.

2. The device according to claim 1, wherein the first module comprises a reactor in one of a rotary reactor, a batch configuration reactor, or a gas stream generator.

3. The device according to claim 2, wherein the reactor heats the carbon-containing materials to temperatures ranging from 300 C to 800 C.

4. The device according to claim 1, wherein the first module further comprises a plasma discharge device.

5. The device according to claim 1, wherein the fixture comprises two electrodes each connected to the respective terminals of the electrical power source and receiving an electrical signal input, a plurality of wires or flat ribbons attached to the two electrodes, and positioned parallel thereto thereby forming a grid pattern.

6. The device according to claim 5, wherein the fixture comprises ultrafine tungsten wire to thereby increase the density of suitable sites for collecting nano particles.

7. The device according to claim 1, wherein the fixture is positioned so that the carbon-containing gas passes through the fixture.

8. The device according to claim 1, wherein the plurality of wires or flat ribbons in the fixture can be composed of one or more of the members selected from the group consisting of stainless steel, aluminum, copper, tungsten, and other electrically conductive materials.

9. The device according to claim 5, further comprising a system to modulate properties of the electrical signal input including the properties of current, sine wave shape, frequency and amplitude.

10. A method to produce carbon nanotubes and hydrogen from carbon-containing materials comprising processing a carbon-containing material by heating to between 300 and 800 C, thereby producing a carbon-containing gas stream in a first module;
capturing particles from the gas stream on a fixture positioned in a second module fluidly connected to the first module;
producing nano particles on the fixture from carbon particles captured from the carbon-containing gas stream, and
harvesting nano particles from the fixture.

11. The method according to claim 10, further comprising impregnating the nano particles on the fixture with an impregnation solution.

12. The method according to claim 11, wherein the impregnation solution comprises one or more of the members selected from the group consisting of iron, cobalt, nickel, platinum, palladium, rhodium, copper, ruthenium, zinc, and other catalytically active metals.

13. The method according to claim 10, wherein the fixture comprises two electrodes each connected to the respective terminals of an electrical power source, a plurality of wires or flat ribbons attached to the two electrodes and positioned parallel thereto thereby forming a grid pattern.

14. The method according to claim 10, further comprising passing an electrical signal input through the wires located on the fixture.

15. The method according to claim 10, further comprising
modulating the properties of the electrical signal input including the properties of current, sine wave shape, frequency and amplitude.

16. The method according to claim 10, wherein the first module further comprises a plasma discharge device.

17. The method according to claim 10, wherein the carbon-containing materials comprise waste materials.
